(19) United States
(12) Patent Application Publication
(10) Pub. No.: US 2007/0065742 A1
(43) Pub. Date: Mar. 22, 2007

(54) Single-component magnetic developer, developing method and image-forming method

(75) Inventors: Daisuke Ishizuka, Minamiashigara-shi (JP); Tomohiro Takeda, Minamiashigara-shi (JP); Toyofumi Inoue, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 11/336,766

(22) Filed: Jan. 23, 2006

(30) Foreign Application Priority Data
Sep. 21, 2005 (JP) 2005-274616

(51) Int. Cl. G03G 9/083

(52) U.S. Cl. 430/106.1; 430/108.6; 430/108.7; 430/122

(57) ABSTRACT

The present invention discloses a single-component magnetic developer having a total energy amount, measured with a powder rheometer at a rotor tip end speed of 100 mm/sec at a rotor helix angle of −5° at a ventilation rate of 20 ml/min, of 10 to 100 mJ; and a developing method, including agitating a developer in a developer container with an agitating member, forming a developer layer on a developer-carrying member, and applying an electric field to a development zone so as to develop a latent image on an electrostatic latent image-holding member with the developer layer, wherein the ratio Va/Vs of the rotational frequency Va of the agitating member to that Vs of the developer-carrying member is 0.05 to 2 and the developer has a total energy amount, measured with a powder rheometer at a rotor tip end speed of 100 mm/sec at a rotor helix angle of −5° at a ventilation rate of 20 ml/min, of 10 to 100 mJ; and an image-forming method including electrically charging an electrostatic latent image-holding member, forming an electrostatic latent image on the surface of the charged electrostatic latent image-holding member; developing the electrostatic latent image with a developer containing a toner to form a toner image, transferring the toner image onto a recording medium, and fixing the toner image on the recording medium, wherein the developer is the single-component magnetic developer.

### CROSS-REFERENCE TO RELATED APPLICATION

This application claims priority under 35 U.S.C. 119 from Japanese Patent Application No. 2005-274616, the disclosure of which is incorporated by reference herein.

### BACKGROUND OF THE INVENTION

1. Field of the Invention

The present invention relates to a single-component magnetic developer, and a developing method and an image-forming method for developing an electrostatic latent image in electrophotographic methods, and electrostatically recording methods.

2. Description of the Related Art

Methods for making image information visible through the use of electrostatic latent images, such as an electrophotographic method, are currently used in various fields. In the electrophotographic method, an electrostatic latent image formed on a photosensitive drum in charging and exposure steps is developed with a developer containing a toner, and the resultant toner image is fixed on a recording medium such as paper through transfer and fixing steps. Examples of the type of the developer used in the development step include two-component developers including a toner and a carrier, and single-component developers including a toner alone such as magnetic toners.

The two-component developing method, which is most widely used, has the following disadvantages. Image quality cannot be maintained for a long time, because toner particles undesirably adhere to the surface of a carrier and the developer therefore deteriorates. In addition, the method requires a control system for keeping the concentration of the toner in the developer constant and a device for mixing a replenished toner with the developer. Therefore, the developing device tends to become large-sized.

The single-component toner developing methods are grouped into single-component magnetic developing methods using a magnetic toner and single-component non-magnetic developing methods using a non-magnetic toner. Although the single-component non-magnetic developing methods are suitable for multicolor printing, fogging, and staining the inside of the developing device easily occur in these methods. This is because the developer can be attracted and held by the developer-carrying member mainly due to the amount of electrostatic charge of the developer. Since the single-component non-magnetic developing methods have such disadvantages, single-component magnetic developing methods are more often used in monochrome image-forming devices.

It is important to stabilize the amount of the electrostatic charge of a toner in order to stabilize image density in the single-component magnetic developing method. Various methods including optimization of external additives have been studied to meet the above condition (see, for example, Japanese Patent Application Laid-Open (JP-A) No. 11-143115).

Developing devices which use the single-component magnetic developing method have an agitating member therein in order to supply a consistent amount of toner to the developer-carrying member. The rotational frequency of the agitating member is adjusted according to such conditions as the shape of the agitating member, the rotational frequency of the developer-carrying member, and the shape and capacity of the developer container.

However, in practice, the toner cannot be supplied sufficiently, because the toner is insufficiently agitated due to changes in the amount of remaining toner or output image patterns. As a result, the toner has an insufficient amount of electrostatic charge and an insufficient amount of toner is held by the developer-carrying member and transported to the development zone, and the developed image has missing portions. Alternatively, excessively large amount of mechanical stress generated by agitation is applied to the toner, and the toner degrades, and image density cannot be kept constant.

To solve these problems, a method in which the ratio of the rotational velocity of the agitating member to that of the developer-carrying member is adjusted to a particular value and in which a toner having wettability with respect to a mixed solution of methanol and water in a particular range is used is disclosed (see, for example, JP-A No. 2004-163476). However, it is still difficult to suppress decrease in image density under stressful conditions, for example, continuous output of high-density images, because the fluidity of the toner has not been controlled in relation to the agitation efficiency of the agitating member.

Methods of respectively controlling the rotational speeds of plural agitating members (see, for example, JP-A No. 2001-201931) and methods of driving an agitating member intermittently (see, for example, JP-A No. 2001-34051) are also disclosed but have problems of increased size of the developing devices and increased cost.

Thus, there exists a need for a single-component magnetic developer, a developing method and an image-forming method that suppress deterioration of image density even during continuous output of high-density images to form high-quality images.

### SUMMARY OF THE INVENTION

Under the above circumstances, the present invention has been made to solve the problems associated with conventional methods.

A first aspect of the invention provides a single-component magnetic developer having a total energy amount, measured with a powder rheometer at a blade tip speed of 100 mm/sec at a blade helix angle of −5° at an aeration rate of 20 ml/min, of 10 to 100 mJ.

A second aspect of the invention provides a developing method, including agitating a developer in a developer container with an agitating member, forming a developer layer on a developer-carrying member, and applying an electric field to a development zone to develop a latent image on an electrostatic latent image-holding member with the developer layer, wherein the ratio Va/Vs of the rotational frequency Va of the agitating member to the rotational frequency Vs of the developer-carrying member is 0.05 to 2 and the developer has a total energy amount, measured with a powder rheometer at a blade tip speed of 100 mm/sec at a blade helix angle of −5° at a ventilation rate of 20 ml/min, of 10 to 100 mJ.

A third aspect of the invention provides an image-forming method including: electrically charging an electrostatic latent image-holding member; forming an electrostatic latent image on the surface of the charged electrostatic latent image-holding member; developing the electrostatic latent image with a developer containing a toner to form a toner image on the electrostatic latent image-holding member; transferring the toner image, which has not been fixed, onto a recording medium; and fixing the toner image on the recording medium, wherein the developer is the single-component magnetic developer.

The invention provides a single-component magnetic developer, a developing method and an image-forming method that suppress deterioration of image density even during continuous output of high-density images to form high-quality images.

### BRIEF DESCRIPTION OF THE DRAWINGS

Preferred embodiments of the invention will be described in detail based on the following figures wherein:

FIG. 1 is a view schematically illustrating the configuration of an example of a developing device used in the developing method of the invention;

FIG. 2A shows a method of measuring total energy amount with a powder rheometer, and FIG. 2B is a graph showing the relationship between the height of blade in a developer layer contained in a measurement vessel and axial force, and FIG. 2C is a graph showing the relationship between the height of the blade in the developer layer contained in the measurement vessel and rotation torque;

FIG. 3 is a graph showing the relationship between the height of a blade in the developer layer contained in the measurement container and energy gradient obtained by the powder rheometer;

FIG. 4 is a view illustrating the shape of the blade used in the powder rheometer; and

FIG. 5 is a view schematically illustrating the configuration of an example of an image-forming apparatus used in the image-forming method of the invention.

### DETAILED DESCRIPTION OF THE INVENTION

<Developing Method>

The developing method of the present invention includes agitating a developer in a developer container with an agitating member, forming a developer layer on a developer-carrying member, and applying an electric field to a development zone to develop a latent image on an electrostatic latent image-holding member with the developer layer. In the developing method, the ratio Va/Vs of the rotational frequency Va of the agitating member to the rotational frequency Vs of the developer-carrying member is 0.05 to 2, and the developer has a total energy amount, measured with a powder rheometer at a blade tip speed of 100 mm/sec at a blade helix angle of −5° at an aeration rate of 20 ml/min, of 10 to 100 mJ.

In the case of a single-component developer, the developer is often toner particles, and thus in the present specification, the terms “developer” and “toner (or toner particles)” have the same meaning in some cases.

The reason why image density easily decreases in successively outputting various high-density images is that the amount of a developer supplied through agitation is insufficient. Efficiency of toner supply through agitation has been found to greatly depend on the state of a toner during agitation.

Since a latent image on an electrostatic latent image-holding member is developed with a developer layer formed on a developer-carrying member in a developing method using a single-component magnetic developer, a certain amount of a developer should be supplied to the developer-carrying member. However, the bulk density of toner powder depends on the amount of a remaining toner and toner agitation history reflecting printing history, and the fluidization behavior of a developer with respect to agitation by an agitating member depends on the state of the toner. As a result, the amount of the developer supplied to the developer-carrying member fluctuates significantly. Therefore, in practice, it is difficult to consistently supply the developer to the developer-carrying member.

The inventors of the invention studied the fluidization characteristics of a developer that enable most consistent agitation of the developer with the agitating member contained in a developing device, most consistent supply of the developer to a developer-carrying member, and a decrease in mechanical stress generated by agitation in a developing method in which a latent image on an electrostatic latent image-holding member is developed with a developer layer formed on the developer-carrying member. As a result, they have found that the fluidization characteristics have a close relationship with a total energy amount measured with a powder rheometer at a blade tip speed of 100 mm/sec at a blade helix angle of −5 at an aeration rate of 20 ml/min.

The reason for this has not been clarified yet, but is thought to be as follows. The state of the toner to which air has been supplied at an aeration rate of 20 ml/min is quite similar to the state of the toner which has been just agitated with an agitating member in a developing device. This is thought the reason why the total energy amount at an aeration rate of 20 mL/min has a correlation with toner-supplying efficiency. Optimizing the total energy amount can stabilize toner-supplying efficiency.

Additional studies reveals that, when a single-component magnetic developer having a total energy amount, measured under the above measurement condition, of 10 to 100 mJ is used and the ratio of the rotational frequency Va of an agitating member to that Vs of a developing roll (developer-carrying member) (Va/Vs) is about 0.05 to about 2, good toner-supplying efficiency can be stably obtained and image density does not easily decrease even in successively or continuously outputting high-density images.

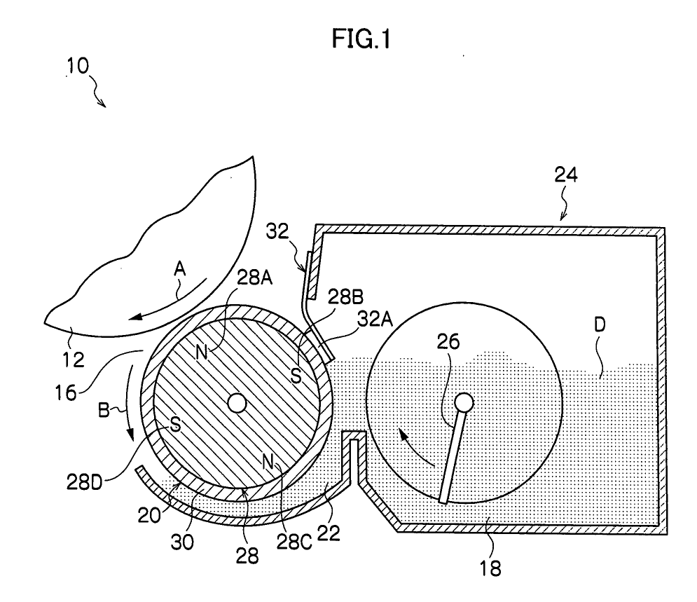

FIG. 1 is a view schematically illustrating a general developing device 10 used in the developing method of the invention, but the developing device usable in the invention is not limited thereto.

The developing device 10 has a housing 24 and the housing 24 has a developer container 18 for holding a developer D and a developing roll container 22 for holding a developing roll (developer-carrying member) 20. The housing 24 also has an opening which communicates with the developer container 18 and the developing roll container 22, and the developer D agitated with an agitating member 26 is supplied from the developer container 18 through the opening to the developing roll container 22.

In the developing method of the invention, the ratio of the rotational frequency Va (rpm) of the agitating member 26 to that Vs (rpm) of the developing roll (developer-carrying member) 20 (Va/Vs) is about 0.05 to about 2, preferably about 0.06 to about 1.8, and more preferably about 0.07 to about 1.5. When the ratio Va/Vs is smaller than about 0.05, the amount of the toner supplied is insufficient in some cases, resulting in deteriorated image density. When the ratio Va/Vs is more than about 2, the toner is excessively agitated, which may cause application of excessive stress to the toner, may accelerate sinking of the external additives in the toner particles and may decrease image density with consumption of the toner.

An open area 16 is provided above the developing roll container 22. A part of the developing roll 20 is exposed and faces a photosensitive drum (electrostatic latent image-holding member) 12 in the open area 16. The region where the developing roll 20 faces the photosensitive drum 12 is a development zone, to which the developer D held on the developing roll 20 is transported by rotation of the developing roll 20. A power supply (not shown) for applying a development bias to the developing roll 20 is electrically connected to the developing roll 20.

The developing roll 20 has a magnet roll 28 and a non-magnetic hollow cylindrical development sleeve 30 covering the magnet roll 28. The magnet roll 28 has plural magnetic poles (four poles in this embodiment) and is so fixed as not to rotate. The plural magnetic poles are north poles 28A and 28C and south poles 28B and 28D and these north and south poles are disposed alternately. The non-magnetic hollow cylindrical development sleeve 30 rotates in one direction (direction B in FIG. 1).

The development sleeve 30 can be a substrate alone, a substrate whose surface has been treated by, for example, oxidation, metal plating, polishing, or blasting, or a substrate coated with a resin and/or a charge control agent.

The material, shape, and/or structure of the substrate may be selected properly according to the usage of the development sleeve 30. The shape is generally hollow cylindrical. Examples of the material include aluminum, copper, electroless copper, nickel, electroless nickel, diffused nickel-cadmium, hard chromium, black chromium, gold, silver, rhodium, platinum, palladium, ruthenium, tin, indium, iron, and cadmium. An alumite (aluminum oxide) film is most widely used as the oxide film, but the oxide film can also be a film of molybdic acid, iron oxide or copper oxide.

Examples of the material of the resin layer include phenol resins, epoxy resins, melamine resins, polyurea, polyamide resins, polyimide resins, polyurethane resins, polycarbonate resins, acrylic resins, styrene resins, fluororesins, and silicone resins. An electrically conductive substance may be dispersed in the resin layer.

A layer-forming blade (layer thickness-adjusting member) 32 is attached to the housing 24. The layer-forming blade 32 abuts the surface of the development sleeve 30 and forms a thin layer of the developer D on the development sleeve 30.

The layer-forming blade 32 has a main body and a part which abuts the surface of the development sleeve 30. The main body is a plate made of stainless steel, copper, iron, or a resin. The part is a rubber member 32A.

Examples of the material of the rubber member 32A include silicone rubbers, urethane rubbers, butadiene rubbers, natural rubbers, isoprene rubbers, styrene-butadiene rubbers, butyl rubbers, nitrile-butadiene rubbers, chloroprene rubbers, ethylene propylene rubbers, and epichlorohydrin rubbers.

The agitating member 26 is required to have a shape which makes it possible to agitate the toner, and otherwise it is not particularly limited. The agitating member 26 preferably has a supporting member serving as a rotating shaft, and a resin sheet, such as a PET sheet, pasted on the supporting member.

The behavior of the single-component magnetic developer of the invention during development in such a developing device will be described below.

The developer is agitated and conveyed by rotation of the agitating member 26 in the developer container 18 and is fed from the developer container 18 through the opening into the developing roll container 22. The developer adheres to the surface of the development sleeve 30 under the magnetic force of the magnet roll 28. The thickness of the developer is adjusted by the overhang and pressure of the rubber member 32A of the layer-forming blade (layer thickness-adjusting member) 32, and the developer is electrically charged. The developer electrically charged and conveyed onto the development sleeve 30 migrates to the electrostatic latent image-holding member (photosensitive drum) 12 according to the amount of electrostatic charge and is used in development.

The developer on regions of the developer-carrying member which regions correspond to the electrostatic latent image is consumed, while that on the other regions is not consumed. The developer in the developing roll container 22 is newly added to the remaining developer on the developer-carrying member, and the combined developer passes through the region under the layer-forming blade 32 and forms a developer layer again.

In the case of a developer having a total energy amount out of the range described above, the amount thereof conveyed to the developer-carrying member is inconstant, often resulting in decreased image density.

The single-component magnetic developer in the invention has a total energy amount, measured with a powder rheometer at a blade tip speed of 100 mm/sec at a blade helix angle of −5° at an aeration rate of 20 ml/min, of about 10 to about 100 mJ, as described above.

The developer having a total energy amount in the above range shows stable fluidity, which does not depend on the state of the toner, and is thus smoothly fed onto the developer-carrying member.

Next, measurement of fluidity of a developer by a powder rheometer will be more minutely described.

Measurement of fluidity of particles is affected by more factors than measurement of fluidity of a liquid, a solid, or a gas. Therefore, it is difficult to specify precise fluidity of particles by using parameters employed conventionally such as the diameter or surface roughness of the particles. Further, even when a factor (e.g. particle diameter) which affects the fluidity is found, the factor may only give a small impact on the fluidity. Alternatively, measurement of the factor may be meaningful only when the factor is combined with other specific factor(s). Therefore, it is difficult to determine the factor(s) to be measured.

Further, fluidity of powder greatly depends on external environmental factors. In contrast, even if the measurement environment fluctuates, the fluctuation range of fluidity of, for example, liquid is not so wide. Meanwhile, fluidity of particles greatly depends on external environmental factors such as humidity and the state of gas used to fluidize the particles. It has been unclear so far which of the measurement factors is affected by these external environmental factors. Therefore, even if measurement of fluidity is carried out under strict measurement conditions, the measurement values are, practically, poorly reproducible.

Regarding fluidity of toner particles in a development tank, the angle of repose and the bulk density have been employed as the indexes of fluidity. However, these physical values indirectly relate to the fluidity and thus it is difficult to quantify and control the fluidity.

On the contrary, a powder rheometer enables measurement of the total amount of energy which the carrier applies to the blade assembly (blade and spindle) of a measurement apparatus, so that a value reflecting the respective factors attributed to the fluidity can be obtained. Therefore, the powder rheometer enables direct measurement of fluidity of a developer without preparing a developer having adjusted surface physical properties and an adjusted particle size distribution, determining items to be measured of the developer, finding optimum physical values for the respective items and actually measuring the items, which is conventionally needed. As a result, confirming whether the value measured by the powder rheometer is within the range alone makes it possible to judge whether a developer is suitable for electrostatic image development. With respect to keeping fluidity of a developer constant, such production control of the developer is much more practical than a conventional method of controlling an indirect value. Further, it is easy to keep measurement conditions constant. Thereby, measurement values are highly reproducible in such production control. In other words, the method of specifying fluidity by use of the value obtained by the powder rheometer is simpler and more highly reliable and provides more precise results than conventional methods.

As described above, the total energy amount, measured with a powder rheometer at a blade tip speed of 100 mm/sec at a blade helix angle of −5° at an aeration rate of 20 ml/min, of a developer being within the range of about 10 to about 100 mJ is very effective in suppressing uneven image density caused by uneven amount of electrostatic charge of a developer on a developer-carrying member. The developer having a total energy amount in the above range has stable fluidity in a developing device, is sufficiently fed onto the developer-carrying member, and suppresses decrease in image density even in successively outputting high-density images.

A developer having a total energy amount, measured with a powder rheometer under the above conditions, of less than about 10 mJ has excessively high fluidity and may scatter from the vicinity of the developer-carrying member and may stain the inside of an image-forming apparatus. Moreover, such a developer is not practical from the viewpoint of productivity. On the other hand, a developer having a total energy amount of more than about 100 mJ is supplied insufficiently by an agitating member, and thus cannot suppress decrease in image density.

The total energy amount is preferably in the range of about 20 to about 90 mJ and more preferably in the range of about 30 to about 80 mJ.

Next, a measurement method with a powder rheometer will be described.

A powder rheometer is a fluidity measurement apparatus in which axial force and rotation torque obtained by spirally rotating a blade in packed particles are simultaneously measured to directly obtain fluidity of the particles. Simultaneous measurement of the rotation torque and axial force makes it possible to detect fluidity which reflects influence of the characteristics of powder itself and that of the external environment at a high sensitivity. Also, since the measurement is carried out in the state where the packed state of the particles is kept constant, data with good reproducibility can be obtained.

In the invention, FT 4 manufactured by Freeman Technology is employed as the powder rheometer. A developer is left at a temperature of 22° C. at a relative humidity of 50% for at least eight hours before measurement in order to eliminate the influence of temperature and humidity.

First, a 50×160 ml split vessel kit is provided which has a hollow cylindrical shape having an internal diameter of 50 mm and which is composed of a lower container having a height of 89 mm and a capacity of 160 milliliters and an upper container having a height of 51 mm. A developer is put into the split vessel so that the height of the packed developer layer in the split vessel is more than 89 mm.

After the developer is put into the split vessel, the packed developer is gently agitated to homogenize the sample. This operation is referred to as conditioning.

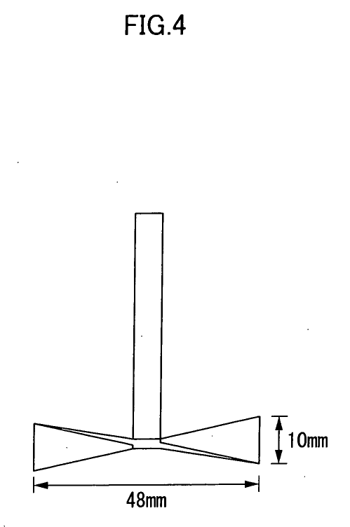

In the conditioning, a blade is gently rotated in the packed developer in a rotation direction in which the blade receives no resistance of the developer, so that no stress is applied to the developer. Which direction is such a rotation direction depends on the inclination direction of the blade of the rotor. However, in the case of the rotor blade shown in FIG. 4, the rotation direction is counterclockwise when seen from the upper side. The conditioning almost completely removes excess air and partial stress and homogenizes the sample. In the conditioning, the sample is agitated at a helix angle of 5° at a rotor tip end speed of 60 mm/s.

The blade moves downward while it rotates. Therefore, the tip end of the blade helically moves. The angle of the helical route along which the blade tip end moves is called a helix angle.

After this conditioning operation is repeated four times, the upper vessel of the split vessel is gently horizontally slid to remove the portion of the developer which portion overflows the lower vessel having a height of 89 mm. Thus, the developer with which the lower vessel having a capacity of 160 milliliters is filled is remained. The reason why such an operation is performed is that it is important to obtain powder always having a constant volume in strictly measuring a total energy amount recited in the invention.

The residual developer is then transferred into a measurement vessel kit (vessel having an internal diameter of 50 mm, a height of 140 mm and a capacity of 200 milliliters and aeration base (meshy bottom plate through which air can pass). Conditioning of the developer transferred into the measurement vessel is conducted five times. Thereafter, a rotation torque and an axial force are measured, while air is being introduced into the developer at an aeration rate of 20 ml/min, and the blade which is being rotated at a tip end speed of 100 mm/s is being moved downward in the developer packed in the measurement vessel from a position having a height of 110 mm from the bottom of the vessel to another position having a height of 10 mm from the bottom at a helix angle of −5°. The rotation direction of the blade at the time of the measurement is opposite to that during the conditioning and, in other words, is clockwise when seen from the upper side.

The reason why air is introduced at an aeration rate of 20 ml/min at the time of the measurement is to make the state of the developer packed in the vessel approximate the actual fluidization state of a developer in a developing device. The aeration rate of 20 ml/min is thought to enable reproduction of the fluidization state of a developer which has been just agitated with an agitating member. The flow state of the introduced air can be controlled in FT4 device manufactured by Freeman Technology.

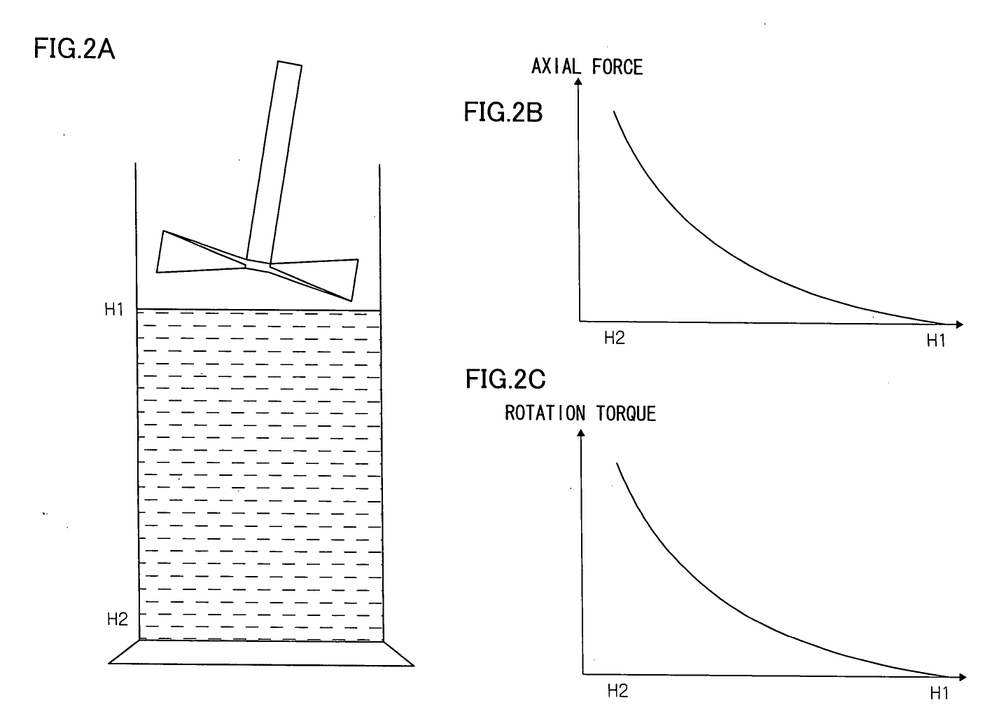

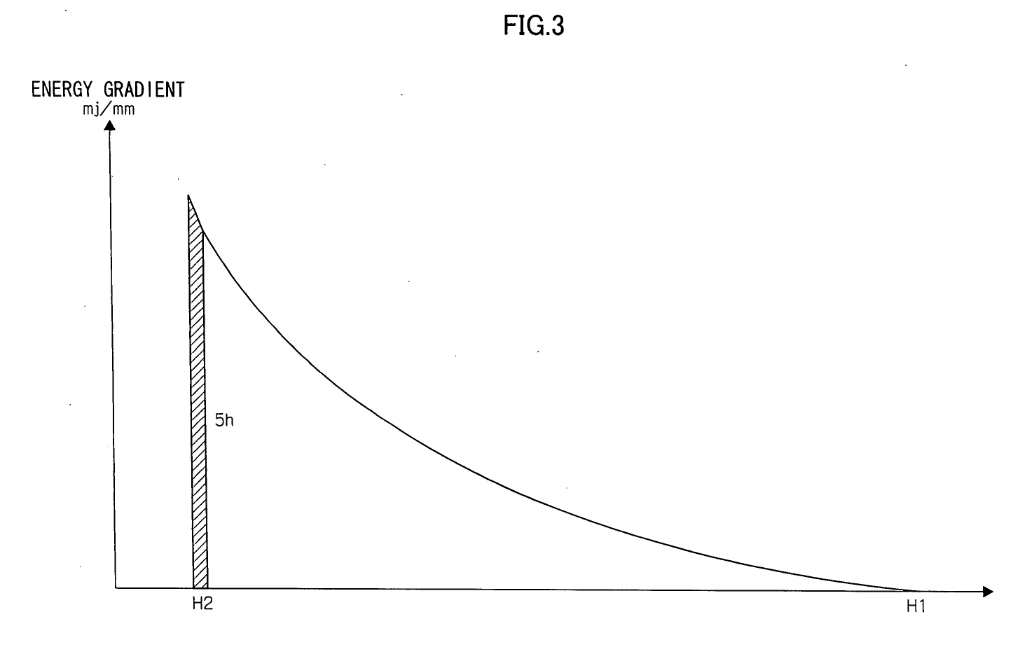

The relationship between axial force and the height H of a blade in the developer layer contained in a measurement vessel from the bottom face and that between rotation torque and the height H are shown in FIGS. 2B and 2C, respectively. The relationship between the height H and energy gradient (mJ/mm) calculated from the rotation torque and the axial force is shown in FIG. 3. An area (hatched area in FIG. 3) obtained by integrating the energy gradient shown in FIG. 3 corresponds to a total energy amount (mJ). The total energy amount recited in the invention is obtained by integrating a portion of the energy gradient which portion has an end point at a height of 10 mm from the bottom face and another end point at a height of 110 mm from the bottom face.

In order to minimize the influence of errors, values obtained by respectively repeating the conditioning and the energy measurement five times are averaged and the resultant average is used as the total energy amount (mJ) defined in the invention.
The blade used is a “48 dia.×10 wide type” blade assembly with a propeller having two blades and a diameter of 48 mm and a width of 10 mm shown in FIG. 4 and manufactured by Freeman Technology.

At least one of the shape, wax amount, and particle size distribution of toner particles, and the kind and amount of an external additive can be so adjusted as to control the total energy amount, measured under the above conditions, of a developer (toner particles) within the recited range. It is preferable to adjust two or more of the above factors.

At least two kinds of inorganic particles, including small-diameter inorganic particles having a number average diameter of about 5 to about 20 nm and large-diameter inorganic particles having a number average diameter of about 30 to about 80 nm, can be used as external additives in order to control the total energy amount of the developer of the invention within the recited range. When such at least two kinds of inorganic particles are used, the large-diameter inorganic particles are preferably added to toner mother particles before adding the small-diameter inorganic particles thereto.

The developer (toner particles) of the invention can have a composition described later and can be obtained by a production method described below.

Hereinafter, the single-component magnetic developer of the invention will be described in detail.

The single-component magnetic developer of the invention is required to have a total energy amount in the recited range and otherwise it is not limited. Any known technique can be applied to the developer of the invention.

The developer preferably contains a toner (toner particles) including toner mother particles and external additives added to the surfaces of the toner mother particles. The toner mother particles may contain a binder resin and a magnetic powder. The external additives include at least two kinds of inorganic particles, i.e., small-diameter inorganic particles having a number average diameter of about 5 to about 20 nm, and large-diameter inorganic particles having a number average diameter of about 30 to about 80 nm. The large-diameter inorganic particles are preferably added before addition of the small-diameter inorganic particles.

Hereinafter, the composition and physical properties of the toner particle will be described.

Binder Resin

The binder resin of the toner particles may be properly selected from known resins which can be used in toner particles. Examples thereof include homopolymers and copolymers of styrenes such as styrene and chlorostyrene, monoolefins such as ethylene, propylene, butylene, and isobutylene, vinyl esters such as vinyl acetate, vinyl propionate, vinyl benzoate, and vinyl butyrate, α-methylene fatty monocarboxylic acid esters such as methyl acrylate, ethyl acrylate, butyl acrylate, octyl acrylate, dodecyl acrylate, phenyl acrylate, methyl methacrylate, ethyl methacrylate, butyl methacrylate, and dodecyl methacrylate, vinyl ethers such as vinyl methyl ether, vinyl ethyl ether, and vinyl butyl ether, and vinyl ketones such as vinyl methyl ketone, vinyl hexyl ketone, and vinyl isopropenyl ketone. The binder resin is preferably polystyrene, styrene-alkyl acrylate copolymer, styrene-alkyl methacrylate copolymer, styrene-acrylonitrile copolymer, styrene-butadiene copolymer, styrene-maleic anhydride copolymer, polyethylene, and/or polypropylene. The binder resin can also be polyester, polyurethane, epoxy resin, silicone resin, polyamide, and/or modified rosin.

Among them, the binder resin is more preferably a styrene-(meth)acrylic ester copolymer resin and/or a polyester resin.

The molecular weight of the binder resin depends on the kind of the resin. However, the weight-average molecular weight Mw thereof is preferably about 10,000 to about 500,000, more preferably about 15,000 to about 300,000, and still more preferably about 20,000 to about 200,000. The number-average molecular weight Mn thereof is preferably about 2,000 to about 30,000, more preferably about 2,500 to about 20,000, and still more preferably about 3,000 to about 15,000.

The weight- and number-average molecular weights are measured with gel permeation chromatography (GPC). The GPC apparatus used is HLC-8120GPC, SC-8020 (manufactured by Toso Corporation), and the (two) columns are TSK GEL, SUPER HM-H (manufactured by Toso Corporation, and having an inner diameter of 6.0 mm and a length of 15 cm), and the eluant is tetrahydrofuran (THF). As for experimental conditions, the sample concentration is 0.5 mass %, and the flow rate is 0.6 mil/min, and the sample injection amount is 10 μl, and the measurement temperature is 40° C. The detector is an IR detector.

The glass transition temperature of the binder resin is preferably about 40° C. to about 80° C., and more preferably about 45° C. to about 75° C. in order to suppress deterioration of fluidity of the toner under a high-temperature environment and to attain fixability of the toner at a low temperature.

The glass transition temperature (Tg) is measured with a differential scanning calorimeter (DSC-50 manufactured by Shimadzu Corporation) at a programming rate of 10° C./minute. The glass transition temperature is a temperature at the intersection of the base line and the rising line in the endothermic region.

Magnetic Powder

The magnetic powder can be any known one, and examples of the material of the magnetic powder include metals such as iron, cobalt, and nickel, and alloys thereof; metal oxides such as Fe₃O₄, γ-Fe₂O₃, and cobalt-doped iron oxide; ferrites such as MnZn ferrite and NiZn ferrite; magnetite, and hematite, and those obtained by treating the above materials with a surface-finishing agent such as a silane coupling agent or a titanate coupling agent, or by coating the above materials with an inorganic material such as a silicon or aluminum compound, or a polymer.

The content of the magnetic powder in the developer particles is preferably in the range of about 35 to about 55 mass % and more preferably in the range of about 40 to about 50 mass %. When the content is less than about 35 mass %, the developer-attracting force of the magnets in the developer-carrying member decreases, which causes scattering of the developer and fogging. On the other hand, when the content is more than about 55 mass %, decreased image density is obtained.

The magnetic powder preferably has a volume average diameter of about 0.05 to about 0.35 μm from the viewpoint of dispersibility thereof in the binder resin.

The toner mother particles can be prepared according to a known production method. The production method is not particularly limited, and may be properly selected according to usage of the toner.

For example, the toner mother particles can be produced by a kneading pulverization method. In this method, a binder resin, a colorant, and optionally a charge control agent are preliminary mixed, and the resultant mixture is melted and kneaded with a kneader, cooled down and pulverized, and the resultant particles are classified with a vibration or air classifier.

Alternatively, the toner mother particles may also be produced by a wet rounding method, a suspension granulation method, a suspension polymerization method, or an emulsion polymerization aggregation method.

External Additive

The developer of the invention can contain external additives so as to control the transferability, fluidity, cleanability and amount of electrostatic charge of the toner, particularly to improve fluidity. The external additives are particles that adhere to the surfaces of the toner mother particles.

As described above, at least two kinds of inorganic particles including small-diameter inorganic particles having a number average diameter of about 5 to about 20 nm and large-diameter inorganic particle having a number average diameter of about 30 to about 80 nm are preferably used as the external additives in the invention. Use of at least two kinds of external additives having different primary particle diameters enables control of minute irregularities on the toner particle surfaces and adjustment of adhesion between the toner particles and fluidity of the toner particles. As a result, the total energy amount measured with a powder rheometer can be controlled.

Examples of the materials of the inorganic particles include metal oxides and ceramics such as silica, aluminum oxide, titanium oxide, barium titanate, magnesium titanate, calcium titanate, strontium titanate, zinc oxide, quartz sand, clay, mica, wollastonite, diatomaceous soil, cerium chloride, bengala, chromium oxide, cerium oxide, antimony trioxide, magnesium oxide, magnesium carbonate, zirconium oxide, silicon carbide, silicon nitride, calcium carbonate, and barium sulfate. One kind of these particles may be used alone or two or more kinds of them can be used together.

Organic particles may be further added to the surfaces of the toner mother particles, and examples of the material of the organic particles include vinyl polymers such as styrene polymers, (meth)acrylic polymers, and ethylene polymers; polyesters, melamine polymers, amide polymers, and allyl phthalate polymers; fluoropolymers such as polyvinylidene fluoride; and higher alcohols such as behenyl alcohol.

The inorganic particles preferably contain at least one kind of silica, aluminum oxide, titanium oxide, and zinc oxide particles, and more preferably contain silica and/or titanium oxide particles, and still more preferably contain silica particles.

The number average diameter of the small-diameter inorganic particles is preferably about 5 to about 20 nm, more preferably about 5 to about 16 nm, and still more preferably about 5 to about 14 nm. When the number average diameter of the small-diameter inorganic particles is less than about 5 nm, the particles sink in the toner mother particles and do not contribute to fluidity of the toner particles. On the other hand, when the number average diameter is more than about 20 nm, the inorganic particles easily separate from the toner particles, and do not contribute to fluidity of the toner particles, and the free external additives accumulate in a developing device.

The number average diameter of the large-diameter inorganic particles is preferably about 30 to about 80 nm, more preferably about 30 to about 70 nm, and still more preferably about 35 to about 65 nm. When the number average diameter is less than about 30 nm, the difference between the diameter of the small-diameter external additive particles and that of the large-diameter external additive particles is small, making it difficult to control the total energy amount measured with a powder rheometer. On the other hand, when the number average diameter is more than about 80 nm, particles having such a large diameter have decreased adhesion to the toner mother particles, and the desired structure of the toner cannot be kept, and toner-supplying efficiency deteriorates.

The number average diameter of each of the external additives can be obtained through observation of a sample, the external additive particles embedded in an epoxy resin, under a transmission electron microscope (TEM).

The total content of the external additives is preferably about 0.5 to about 10 mass %, more preferably about 0.6 to about 8 mass %, and still more preferably about 0.8 to about 6 mass % with respect to the content of the toner mother particles. When the total content is less than about 0.5 mass %, fluidity of the toner is insufficient, making it difficult to control the total energy amount, measured with a powder rheometer at an aeration rate of 20 ml/min, within the range of about 10 to about 100 mJ. Also, the chargeability of the toner is insufficient, which easily causes a decrease in image density. When the total content is more than about 10 mass %, the amount of free external additives increases, often causing staining of a photosensitive drum and a charging unit.

The surface-coating rate, calculated according to the following Formula (1), of the toner is preferably about 50 to about 600%, more preferably about 60 to about 550%, and still more preferably about 70 to about 500%. When the surface-coating rate is within the above range, it is easy to prepare toner particles that have a total energy amount, measured with a powder rheometer, in the range recited in the invention.
Surface-coating rate=

$$\frac{\sqrt{3} {D}_{N} {ρ}_{N} X}{2 \frac{{D}_{a}}{1000} {ρ}_{a}} \qquad Formula ( 1 )$$

In the above formula, D_{N} represents the average diameter (μm) of the toner mother particles; ρ_{N} represents the density of the toner mother particles; Dₐ represents the average diameter of the external additive particles (nm); ρₐ represents the density of the external additive; and X represents the addition amount of the external additive (mass %).

The amount of the large-diameter inorganic particles is preferably about 40 to about 800 parts by mass, more preferably about 50 to about 700 parts by mass, and still more preferably about 60 to about 600 parts by mass with respect to 100 parts by mass of the small-diameter inorganic particles. When the amount is less than about 40 parts by mass, it is difficult to sufficiently control surface irregularities of the toner particles and it becomes difficult to control the total energy amount to 100 mJ or less. When the amount is more than about 800 parts by mass, staining of a photosensitive drum and a charging unit easily occurs.

The inorganic particles serving as the external additives are preferably subjected to surface treatment. The surface treatment improves fluidity of the toner particles (powder) and is effective in reducing the degree of dependency of chargeability of the toner on environment. The surface treatment may be performed by, for example, immersing the inorganic particles in a surface-finishing agent. The type of the surface-finishing agent is not particularly limited, and examples of the surface-finishing agent include silane coupling agents, silicone oils, titanate coupling agents, and aluminum coupling agents. One of these agents may be used alone or two or more of them can be used together. Among them, the surface-finishing agent is preferably a silane coupling agent.

The silane coupling agent can be chlorosilane, alkoxysilane, silazane, or a special silylating agent. Typical examples thereof include methyltrichlorosilane, dimethyldichlorosilane, trimethylchlorosilane, phenyltrichlorosilane, diphenyldichlorosilane, tetramethoxysilane, methyltrimethoxysilane, dimethyldimethoxysilane, phenyltrimethoxysilane, diphenyldimethoxysilane, tetraethoxysilane, methyltriethoxysilane, dimethyldiethoxysilane, phenyltriethoxysilane, diphenyldiethoxysilane, isobutyltriethoxysilane, decyltrimethoxysilane, hexamethyldisilazane, N,O-(bistrimethylsilyl)acetamide, N,N-(trimethylsilyl)urea, tert-butyldimethylchlorosilane, vinyltrichlorosilane, vinyltrimethoxysilane, vinyltriethoxysilane, γ-methacryloxypropyltrimethoxysilane, β-(3,4-epoxycyclohexyl)ethyltrimethoxysilane, γ-glycidoxypropyltrimethoxysilane, γ-glycidoxypropylmethyldiethoxysilane, γ-mercaptopropyltrimethoxysilane, and γ-chloropropyltrimethoxysilane.

The surface treatment of the external additive particles may be conducted by a conventionally known method, including the following manners. A surface-finishing agent is diluted with a solvent such as tetrahydrofuran, toluene, ethyl acetate, methyl ethyl ketone, or acetone, and the resultant solution is dripped or sprayed on the particles which are being agitated with, for example, a blender to sufficiently mix the solution and the external additive particles. The resultant particles are washed and the resultant mixture including the particles and the washing liquid is filtered, if necessary. The particles are heated and dried, and the resultant agglomerates are crushed with a blender, or a mortar. Alternatively, the external additive particles are immersed in a solution obtained by dissolving a surface-finishing agent in a solvent, and the particles are dried. Alternatively, the external additive particles are dispersed in water to form a slurry, and a surface-finishing agent solution is dripped into the slurry. The particles are then allowed to sediment, and are heated, dried, and crushed. Alternatively, a surface-finishing agent is directly sprayed on the particles.

The external additives are adhered to or fixed on the surfaces of the toner mother particles by applying mechanical impact force to the developer particles and the external additives with, for example, a sample mill, or a HENSCHEL mixer.

As described above, the large-diameter inorganic particles are preferably added to the surfaces of the toner mother particles before addition of the small-diameter inorganic particles thereto in preparing the developer of the invention. In this case, the small-diameter inorganic particles coat the surfaces of the large-diameter external additive particles previously added as well as the surfaces of the toner mother particles, enabling control of minute irregularities on the toner outermost layer and ensuring desired fluidity. Timing of addition is not particularly limited, as long as the large-diameter inorganic particles and the small-diameter inorganic particles are added in that order.

Others Additives

The single-component magnetic developer of the invention may further contain at least one of known materials used in developers.

Wax

The developer of the invention preferably contains wax to improve offsetting resistance of the toner. Examples of the wax in the invention include paraffin wax and derivatives thereof, montan wax and derivatives thereof, microcrystalline wax and derivatives thereof, Fischer-Tropsch wax and derivatives thereof, and polyolefin wax and derivatives thereof. Examples of the derivatives include oxides of the above wax, polymers of at least one of the above wax and at least one vinyl monomer, and graft-modified products of the above wax. The wax may also be alcohol, fatty acid, vegetable wax, animal wax, mineral wax, ester wax, and/or acid amide.

Specifically, the wax is, for example, hydrocarbon wax such as low-molecular weight polypropylene or low-molecular weight polyethylene, microcrystalline wax, silicone resin, rosin, ester wax, rice wax, carnauba wax, Fischer-Tropsch wax, montan wax, and/or candelilla wax.

The content of the wax in the toner particles is preferably in the range of about 0.1 to about 10 mass %, and more preferably in the range of about 1 to about 8 mass %.

When the content of wax is less than about 0.1 mass %, the toner may have a decreased releasing property, and may easily cause offsetting. When the content is higher than about 10 mass %, the toner may have decreased chargeability and a decreased heat-retaining property.

Colorant

The developer of the invention may also contain a colorant to adjust color tone. The type of the colorant is not particularly limited, and is properly selected according to usage of the developer, and any known colorant may be used. Examples of the colorant include carbon black, lamp black, DuPont Oil Red, Orient Oil Red, rose bengal, C.I. Pigment Red 5, 112, 123, 139, 144, 149, 166, 177, 178, 222, 48:1, 48:2, 48:3, 53:1, 57:1, and 81:1, C.I. Pigment Orange 31 and 43, quinoline yellow, Chrome yellow, C.I. Pigment Yellow 12, 14, 17, 93, 94, 97, 138, 174, 180, and 188, ultramarine blue, aniline blue, Calco Oil Blue, methylene blue chloride, copper phthalocyanine, C.I. Pigment blue 15, 60, 15:1, 15:2, and 15:3, C.I. Pigment green 7, malachite green oxalate, and nigrosine dye. One of these colorants may be used alone, or two or more of them can be used together. The colorant may be subjected to flushing dispersion.

Charge Control Agent

The developer of the invention may further contain a charge control agent so as to control chargeability of the toner. The charge control agent is, for example, a fluorinated surfactant, a salicylic acid complex, an iron dye such as an iron complex, a chromium dye such as a chromium complex, a polymeric acid such as a copolymer whose monomers include maleic acid, a quaternary ammonium salt, and/or an azine dye such as nigrosine. The content of the charge control agent in the developer may be in the range of about 0.1 to about 10.0 mass %.

Physical Properties of Developer

Volume Average Diameter of Toner Particles

The volume average diameter of the toner particles is preferably about 4 to about 12 μm, more preferably about 4.5 to about 10 μm, and still more preferably about 5 to about 9 μm. When the volume average diameter is less than about 4 μm, the toner has drastically decreased fluidity. Therefore, a developer layer cannot be formed by a layer thickness-adjusting member, and the resultant images have fogging and dirt portions in some cases. On the other hand, when the volume average diameter is more than about 12 μm, images having decreased resolution are obtained rather than high-quality images. Moreover, the amount of electrostatic charge of the developer per unit weight is low, and a developer layer formed cannot be retained, and the resultant images have fogging and dirt portions in some cases.

The volume average diameter of the toner particles is measured as follows. 0.5 to 50 mg of a test sample is added to 2 ml of an aqueous solution containing 5 mass % of a dispersant or a surfactant, preferably sodium alkylbenzenesulfonate, and the resultant mixture is added to 100 to 150 ml of an electrolyte. The test sample-suspended electrolyte is stirred with an ultrasonic disperser for about one minute. Thereafter, the particle size distribution of particles having diameters of 2.0 to 64 μm from the particles contained in the electrolyte is measured with COULTER COUNTER TA-II and an aperture having an aperture diameter of 100 μm. The number of particles measured is 50,000.

The above-described particle size range measured (2.0 to 64 μm) is divided into several size ranges (channels) and a volume cumulative distribution curve is drawn from the smallest range on the basis of the measured particle size distribution. The particle diameter at a cumulative count of 50% is defined as the volume average particle diameter D₅₀ᵥ.

Particle Size Distribution of Toner Particles

As for the preferable particle size distribution of the toner particles, the percentage of the number of toner particles having a particle diameter of 4 μm or less to that of all the toner particles measured is preferably about 45 number % or less, more preferably about 40 number % or less, and still more preferably about 35 number % or less.

In the above-described volume cumulative distribution curve, the particle diameter at a cumulative count of 84% is defined as particle diameter D_{84V}. As in the volume cumulative distribution curve, a number cumulative distribution curve is drawn from the smallest range on the basis of the measured particle size distribution described above. The particle diameter at a cumulative count of 16% is defined as particle diameter D₁₆ₚ, and the particle diameter at a cumulative count of 50% is defined as the number average particle diameter D₅₀ₚ. Here, the ratio of D₈₄ᵥ/D₅₀ᵥ is preferably 1.35 or less, and more preferably 1.30 or less. In addition, the ratio of D₅₀ₚ/D₁₆ₚ is preferably 1.45 or less, and more preferably 1.40 or less.

To obtain toner particles having such a particle size distribution, particles can be classified with a gravity classifier, a centrifugal classifier, an inertia classifier, or a sieve.

When the particle size distribution of toner particles is wider than the above distribution, the total energy amount measured with a powder rheometer tends to be out of the recited range.

As for the particle size distribution of the toner particles, the ratio of D₈₄ᵥ/D₅₀ᵥ is defined as a particle size distribution index on a coarse particle side and the ratio of D₅₀ₚ/D₁₆ₚ is defined as a particle size distribution index on a fine particle side.

Shape Factor of Toner Particles

The shapes of the toner particles are preferably so controlled as to adjust a total energy amount within the range recited in the invention. The shape factor SF1, calculated according to the following Formula (2), of the toner particles is preferably 135 or less, and more preferably 130 or less.
SF1=(ML²/A)×(π/4)×100 Formula (2)

In Formula (2), ML represents the absolute maximum length of a toner particle, and A represents the projected area of the toner particle.

The shape factor SF1 of the toner is measured as follows. Optically microscopic images of at least 1000 toner particles scattered on a slide glass are captured into a LUZEX image analyzer via a video camera, and the maximum length and the projected area of each of these particles are measured, and the SF1 value of each particle is calculated in accordance with Formula (2), and the calculated SF1 values for the respective particles are averaged, and the average is defined as the shape factor of the toner. The closer to 100 the shape factor SF1 is, the more completely spherical the particle is. The greater the shape factor SF1 is, the higher degree of irregularity the particle has.

To control the shape factor of the toner within the above range, particles prepared by mixing a binder resin, a colorant, and optionally a charge control agent, melting, kneading, cooling, and pulverizing the resultant mixture, and classifying the resulting particles can be heated, or mechanical impulsive force can be applied to the particles. Thereby, rounding of the toner shape can be controlled. Alternatively, the toner having a shape factor within the range can be prepared by conducting a wet production method such as an emulsion aggregation method.

<Image-Forming Method>

The image-forming method of the invention includes: electrically charging an electrostatic latent image-holding member; forming an electrostatic latent image on the surface of the charged electrostatic latent image-holding member; developing the electrostatic latent image with a developer containing a toner to form a toner image on the electrostatic latent image-holding member; transferring the toner image, which has not been fixed, onto a recording medium; and fixing the toner image on the recording medium. The developer used in the development has a total energy amount in the range described above.

In the image-forming method of the invention, any known techniques may be applied to the charging, latent image formation (exposure step), transferring and fixing. The image-forming method may further include cleaning the electrostatic latent image-holding member after the transferring and/or removing the residual charge(s) from the latent image-holding member after the transferring.

The development is conducted as follows. The developer is transferred onto the surface of the developer-carrying member, while the developer is being agitated by the agitating member, as shown in the developing device of FIG. 1. The developer-carrying member holding the developer and facing the electrostatic latent image-holding member rotates. The developer is transferred onto the latent image-holding member to develop the latent image.

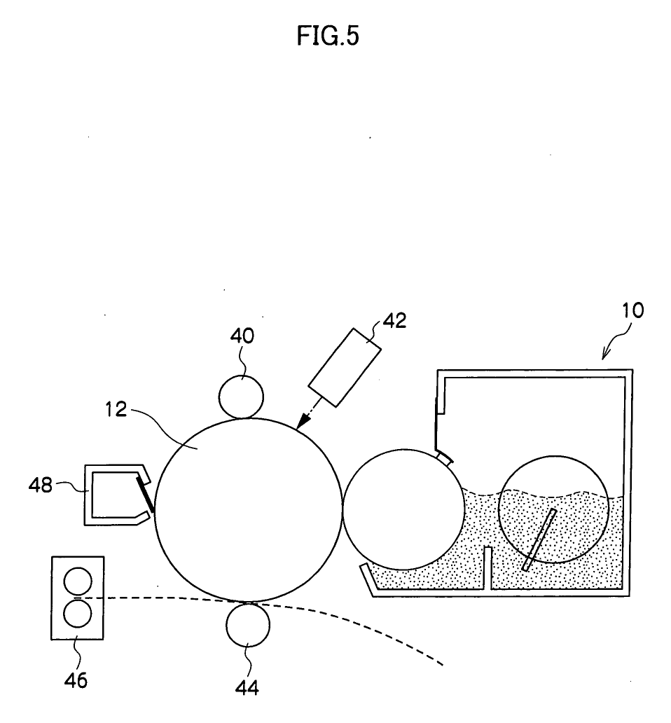

An example of the image-forming apparatus for use in the image-forming method of the invention is shown in FIG. 5. As shown in FIG. 5, the image-forming apparatus preferably has an electrostatic latent image-holding member 12, a unit for electrically charging the electrostatic latent image-holding member 12 (charging unit 40), a unit (light-exposure unit) for irradiating the charged electrostatic latent image-holding member 12 to form an electrostatic latent image on the surface of the electrostatic latent image-holding member 12 (latent image-forming unit 42), a unit for developing the electrostatic latent image with a developer to form a toner image (developing unit 10), a unit for transferring the toner image from the electrostatic latent image-holding member 12 onto a recording medium (transfer unit 44), and a unit for fixing the toner image on the recording medium (fixing unit 46). The apparatus may further have a cleaning unit 48 and/or a unit for removing the residual charge(s) from the latent image-holding member (neutralization unit) (not shown). The type of each of these components, i.e., the electrostatic latent image-holding member (electrophotographic photosensitive member or photosensitive drum) 12, the charging unit 40, the latent image-forming unit 42, the developing unit 10, the transfer unit 44, the fixing unit 46, the cleaning unit 48, and the neutralization unit, is not particularly limited, and these components may have any known configurations in the invention. The developing unit 10 shown in FIG. 5 is the same as the developing device shown in FIG. 1.

### EXAMPLES

Hereinafter, the invention will be described with reference to Examples, but it should be understood that the invention is not limited by these Examples.

<Measurement of Various Properties>

Methods of measuring the physical properties of developers and the binder resins used in Examples and Comparative Examples will be described first.

—Shape Factor—

Optically micrographic images of 1000 toner particles scattered on a slide glass are captured into an image analyzer (LUZEX III manufactured by Nireco Corporation) via a video camera, and the maximum length and the projected area of each particle are measured, and the shape factor SF1 of each particle is calculated from the maximum length and the projected area according to the Formula (2), and the calculated shape factors for the respective particles are averaged, and the average is used as the shape factor of the toner.

—Volume Average Diameter and Particle Size Distribution—

The volume particle diameter and the particle size distribution of the toner are measured with a measurement apparatus, COULTER COUNTER TA-II (manufactured by Beckmann Coulter). At this time, ISOTON-II (manufactured by Beckmann Coulter) is used as an electrolyte.

The measurement is conducted as follows. Ten milligrams of a test sample is added to 2 ml of an aqueous solution containing 5 mass % of sodium alkylbenzenesulfonate, and the resultant mixture is added to 100 to 150 ml of the electrolyte. The test sample-suspended electrolyte is stirred with an ultrasonic disperser for about one minute. Thereafter, the particle size distribution of particles having diameters of 2.0 to 64 μm from the particles contained in the electrolyte is measured with COULTER COUNTER TA-II and an aperture having an aperture diameter of 100 μm. The number of particles measured is 50,000.

The above-described particle size range measured (2.0 to 64 μm) is divided into several size ranges (channels) and a volume cumulative distribution curve is drawn from the smallest range on the basis of the measured particle size distribution. Similarly, a number cumulative distribution curve is drawn from the smallest range on the basis of the measured particle size distribution. The particle diameter at a volume cumulative count of 16% is defined as the volume particle diameter D₁₆ₚ. The particle diameter at a number cumulative count of 16% is defined as the number particle diameter D₁₆ₚ. The particle diameter at a volume cumulative count of 50% is defined as the volume average particle diameter D₅₀ᵥ. The particle diameter at a number cumulative count of 50% is defined as the number average particle diameter D₅₀ₚ. The particle diameter at a volume cumulative count of 84% is defined as the volume particle diameter D₈₄ᵥ. The particle diameter at a number cumulative count of 84% is defined as the number particle diameter D₈₄ₚ. As described above, the volume average diameter is D₅₀ᵥ.

The percentage of the number of toner particles having a particle diameter of 4 μm or less to that of all the toner particles measured is obtained from the particle size distribution.

—Measurement of Molecular Weight Distribution—

The molecular weight distribution of a binder resin is measured with a gel permeation chromatographic (GPC) apparatus, HLC-8120GPC, SC-8020 (manufactured by Toso Corporation). Two columns, TSK GEL, SUPER HM-H (manufactured by Toso Corporation, and having an inner diameter of 6.0 mm and a length of 15 cm), and an eluant, tetrahydrofuran (THF), are used in the measurement. As for experimental conditions, the sample concentration is 0.5 mass %, and the flow rate is 0.6 ml/min, and the sample injection amount is 10 μl, and the measurement temperature is 40° C. An IR detector is also used.

A calibration curve is drawn on the basis of standardized polystyrene sample TSK standard (manufactured by Tosho Corp.) including the following 10 samples: A-500, F-1, F-10, F-80, F-380, A-2500, F-4, F-40, F-128, and F-700. The interval of data collection in the sample analysis is 300 ms.

—Measurement of Glass Transition Temperature—

The glass transition point (Tg) of a binder resin is measured with a differential scanning calorimeter (DSC-50 manufactured by Shimadzu Corporation) at a programming rate of 10° C./minute. The glass transition point is a temperature at the intersection of the base line and the rising line in the endothermic region.

—Measurement of Weight-Average Molecular Weight—

The weight-average molecular weight of the binder resin is measured according to the method described above.

<Preparation of Toner Mother Particles>

Preparation of toner mother particles (1)

| | |
|---|---|
| Binder resin, styrene/n-butyl acrylate resin | 46.5 mass % |
| (the ratio of the amount of the former monomer | |
| to that of the latter monomer of 82/18, Mw of | |
| 140,000, and Tg of 59° C.) | |
| Magnetite (MTH009F manufactured by Toda Kogyo | 50 mass % |
| Corp.) | |
| Polypropylene wax (BISCOL 550-P manufactured | 2.5 mass % |
| by Sanyo Chemical Industries) | |
| Negative charge control agent (iron- | 1.0 mass % |
| containing azo dye) (T-77 manufactured by | |
| Hodogaya Chemical) | |

These components are mixed with a HENSCHEL mixer to obtain a powder mixture, and the mixture is heated and kneaded with an extruder at a setting temperature of 150° C. to obtain a kneaded matter (1). The kneaded matter is cooled down, roughly pulverized, and thoroughly pulverized to obtain particles having a volume average diameter D₅₀ᵥ of 5.7 μm.

The particles are classified and the resultant particles are rounded with a device, NOBILTA manufactured by Hosokawamicron, to obtain toner mother particles (1) (D₅₀, of 6.1 μm, the ratio of D₈₄ᵥ/D₅₀ᵥ of 1.25, and the ratio of D₅₀ₚ/D₁₆ₚ of 1.27). The average shape factor of the toner mother particles is 128.

Preparation of Toner Mother Particles (2)

As in the toner mother particles (1), the kneaded matter (1) is prepared. The kneaded matter is cooled down, roughly pulverized, and thoroughly pulverized to obtain particles having a volume average diameter D₅₀, of 5.2 μm. The particles are classified and the resultant particles are rounded with a device, NOBILTA manufactured by Hosokawamicron, to obtain toner mother particles (2) (D₅₀ᵥ of 5.6 μm, the ratio of D₈₄ᵥ/D₅₀ᵥ of 1.24, and the ratio of D₅₀ₚ/D₁₆ₚ of 1.24). The average shape factor of the toner mother particles is 124.

### Example 1

Preparation of toner (1)

| | |
|---|---|
| Toner mother particles (1) | 100 parts by weight |
| Silica treated with silicone oil (RY300 manufactured | 1.5 parts by weight |
| by Nippon Aerosil and having a primary particle | |
| diameter of 7 nm) | |
| Silica treated with HMDS (H05TM manufactured | 2.3 parts by weight |
| by Wacker Chemie and having a primary particle | |
| diameter of 40 nm) | |

These components are mixed with a HENSCHEL mixer to obtain a toner (1) having the toner mother particles (1) and the external additives added to the surfaces of the toner mother particles (1). Here, the silica treated with silicone oil is added after addition of the silica treated with HMDS. The total energy amount of the toner (1) is measured with a powder rheometer FT4 (manufactured by Freeman Technology) in accordance with the above-described method.

### Examples 2 to 6 and Comparative Examples 1 to 2

Inventive toners (2) to (6) and comparative toners (1) and (2) are prepared in the same manner as in Example 1, except that at least one of the type of the toner mother particles, and the amounts of the silica treated with silicone oil and the silica treated with HMDS is changed into that shown in Table 1. The total energy amounts of the inventive toners (2) to (6) and comparative toners (1) and (2) are summarized in Table 1.

### Comparative Example 3

A comparative toner (3) is prepared in the same manner as in Example 1 of JP-A No. 11-143115. The total energy amount of the comparative toner (3) is shown in Table 1.

Specifically, the toner is prepared in the following manner.

Binder resin, styrene-butyl acrylate copolymer (ratio of the amount of the former monomer to that of the latter monomer of 80/20, and Mw of 800,000) 50 parts by weight

Octahedral magnetite (average particle diameter: 0.19 μm) 45 parts by weight

Negative charge control agent (iron-containing azo dye) 2.0 parts by weight

(T-77 manufactured by Hodogaya Chemical)

Low-molecular weight polypropylene 3.0 parts by weight

(HIWAX P-200 manufactured by Mitsui Petrochemical Industries, and having a softening point of 152° C.)

These components are mixed with a HENSCHEL mixer to obtain a powder mixture, and the mixture is heated and kneaded with an extruder at a setting temperature of 140° C. The kneaded matter is cooled down, roughly pulverized, and thoroughly pulverized to obtain particles having a volume average diameter D₅₀ᵥ of 6.8 μm. The particles are classified to obtain toner mother particles having D₅₀, of 7.3 μm.

1.2 parts by weight of hydrophobic colloidal silica having an average particle diameter of 12 nm, 0.5 parts by weight of hydrophobic colloidal silica having an average particle diameter of 64 nm, and 0.5 parts by weight of magnetite having an average particle diameter of 420 nm are added to the surfaces of the toner mother particles with a HENSHCEL mixer (capacity of 500 liters, and peripheral speed of 20 m/sec) for 15 minutes. At this time, the content of the toner mother particles is 100 parts by weight.

<Evaluation>

Each of the toners of Examples 1 to 6 and Comparative Examples 1 to 3 is set in a device obtained by remodeling a printer, DOCU PRINT 305 manufactured by Fuji Xerox Printing Systems, so as to enable independent control of the rotational frequency Va of the agitating member and that Vs of the developer-carrying member. The following items of the toners are evaluated.
Rotational frequency of agitating member: 30 rpm
Rotational frequency of developer-carrying member: 150 rpm
   Measurement of Initial Image Density

A square solid image having an edge length of 3 cm is printed on a recording medium at 30° C. at 80% RH, and the density of the image is measured with a reflection densitometer X-RITE 404 manufactured by X-rite.

Evaluation of Change in Image Density after Continuous Printing of High-Density Image

An image having an image density of 50% is continuously and repeatedly printed on 200 sheets of paper at 30° C. at 80% RH. Thereafter, the above-described square solid image having an edge length of 3 cm is printed again, and the density of the printed solid image is measured with the reflection densitometer X-RITE 404 manufactured by X-rite. The absolute value of the difference between the image density of the printed solid image and the initial image density (ΔD) is calculated, and evaluated according to the following criteria.

A: ΔD of less than 0.05

B: ΔD of not less than 0.05 and less than 0.10

C: ΔD of not less than 0.10 and less than 0.20

D: ΔD of 0.20 or more

Scattering of Developer from Developing Device

A visual check is made to determine whether the developer has scattered from the developing device when an image has been repeatedly printed on 10,000 sheets of paper.

A: No scattering

B: Slight scattering at a practically acceptable level

C: Significant scattering

TABLE 1

| | | Smaller external | | Larger external | | | | |
|---|---|---|---|---|---|---|---|---|
| | | additive | | additive | | | Decrease in image | |
| | | Average | | Average | | Total | density after | Scattering |
| | Toner | primary | | primary | | energy | continuous printing | of toner from |
| | mother | particle | Parts by | particle | Parts by | amount | of high-density image | developing |
| | particle | diameter | weight | diameter | weight | of toner | on 200 sheets of paper | device |
| Example 1 | 1 | 7 | 1.5 | 40 | 2.3 | 80 | A (0.04) | A |
| Example 2 | 2 | 7 | 1.7 | 40 | 3.0 | 10 | A (0.01) | B |
| Example 3 | 2 | 7 | 1.7 | 40 | 2.6 | 20 | A (0.03) | A |
| Example 4 | 1 | 7 | 2.0 | 40 | 2.0 | 30 | A (0.03) | A |
| Example 5 | 1 | 7 | 1.5 | 40 | 2.1 | 90 | B (0.05) | A |
| Example 6 | 1 | 7 | 1.7 | 40 | 1.7 | 100 | B (0.09) | A |
| Comparative | 2 | 7 | 2.0 | 40 | 3.2 | 7 | A (0.02) | C |
| Example 1 | | | | | | | | |
| Comparative | 1 | 7 | 1.5 | 40 | 0.8 | 120 | D (0.21) | A |
| Example 2 | | | | | | | | |

| | | | | |
|---|---|---|---|---|
| Comparative | Toner prepared in Example 1 of JP-A No. 11-143115 | 160 | D (0.25) | A |
| Example 3 | | | | |

As shown in Table 1, single-component magnetic developers having a total energy amount, measured with a powder rheometer under the above conditions, of 10 to 100 mJ suppress decrease in image density after printing at various image densities and stably provide high-quality images. In contrast, single-component magnetic developers having a total energy amount of less than 10 mJ scatter from the developing device and therefore stain the image-forming apparatus.

The toners of Examples 1 to 6 show a few decrease in image density after continuous printing of a high-density image and do not scatter from the developing device, even when the rotational frequency of the agitating member is 7.5 rpm and that of the developer-carrying member is 150 rpm (Va/Vs of 0.05), or even when the rotational frequency of the agitating member is 160 rpm and that of the developer-carrying member is 80 rpm (Va/Vs of 2.0).

What is claimed is:

1. A single-component magnetic developer having a total energy amount, measured with a powder rheometer at blade tip speed of 100 mm/sec at a blade helix angle of −5 at an aeration rate of 20 ml/min, of 10 to 100 mJ.

2. The single-component magnetic developer of claim 1, wherein the developer comprises a toner having toner mother particles and external additives, and the external additives are small-diameter inorganic particles having a number average diameter of 5 to 20 nm and large-diameter inorganic particles having a number average diameter of 30 to 80 nm.

3. The single-component magnetic developer of claim 2, wherein the small- and large-diameter inorganic particles are made of at least one kind selected from the group consisting of silica, aluminum oxide, titanium oxide, and zinc oxide particles.

4. The single-component magnetic developer of claim 2, wherein the content of the external additives is 0.5 to 10 mass %.

5. The single-component magnetic developer of claim 2, wherein a surface-coating rate at which the surfaces of the toner mother particles are covered with the external additives is 50 to 600%.

6. The single-component magnetic developer of claim 2, wherein the content of the large-diameter inorganic particles is 40 to 800 parts by mass with respect to 100 parts by mass of the small-diameter inorganic particles.

7. The single-component magnetic developer of claim 1, wherein the developer comprises a toner containing a binder resin having a weight-average molecular weight Mw of 10,000 to 500,000.

8. The single-component magnetic developer of claim 1, wherein the developer comprises a toner containing a binder resin having a glass transition temperature of 40 to 80° C.

9. The single-component magnetic developer of claim 1, wherein the developer comprises a toner containing a magnetic powder having a volume average diameter of 0.05 to 0.35 μm.

10. The single-component magnetic developer of claim 9, wherein the content of the magnetic powder in the toner is 35 to 55 mass %.

11. The single-component magnetic developer of claim 1, wherein the developer comprises a toner containing a wax in a content of 0.1 to 10 mass %.

12. The single-component magnetic developer of claim 1, wherein the developer comprises toner particles having a volume average diameter of 4 to 12 μm.

13. The single-component magnetic developer of claim 1, wherein the percentage of the number of toner particles having a particle diameter of 4 μm or less to that of all toner particles is 45% or less.

14. The single-component magnetic developer of claim 1, wherein, when the developer comprises a toner, and the particle size distribution of the toner is measured, and the total particle size range of the particle size distribution is divided into several size ranges, and volume and number cumulative distribution curves are drawn from the respective smallest ranges on the basis of the particle size distribution, and a particle diameter at a volume cumulative count of 50% is defined as D₅₀ᵥ, and a particle diameter at a volume cumulative count of 84% is defined as D₈₄ᵥ, and a particle diameter at a number cumulative count of 16% is defined as D₁₆ₚ, and a particle diameter at a number cumulative count of 50% is defined as D₅₀ₚ, a ratio of D₈₄ᵥ/D₅₀ᵥ is 1.35 or less and a ratio of D₅₀ₚ/D₁₆ₚ is 1.45 or less.

15. The single-component magnetic developer of claim 1, wherein the developer comprises a toner having a shape factor SF1 of 135 or less.

16. A developing method, comprising agitating a developer in a developer container with an agitating member, forming a developer layer on a developer-carrying member, and applying an electric field to a development zone to develop a latent image on an electrostatic latent image-holding member with the developer layer, wherein a ratio Va/Vs of the rotational frequency Va of the agitating member to the rotational frequency Vs of the developer-carrying member is 0.05 to 2 and the developer has a total energy amount, measured with a powder rheometer at a blade tip speed of 100 mm/sec at a blade helix angle of −5° at an aeration rate of 20 ml/min, of 10 to 100 mJ.

17. The developing method of claim 16, wherein the developer contains toner mother particles containing a binder resin and a magnetic powder, and external additives added to the surfaces of the toner mother particles and the external additives include small-diameter inorganic particles having a number average diameter of 5 to 20 nm and large-diameter inorganic particles having a number average diameter of 30 to 80 nm.

18. The developing method of claim 17, wherein the large-diameter inorganic particles are added before addition of the small-diameter inorganic particles in preparing the developer.

19. An image-forming method comprising: electrically charging an electrostatic latent image-holding member; forming an electrostatic latent image on the surface of the charged electrostatic latent image-holding member; developing the electrostatic latent image with a developer containing a toner to form a toner image on the electrostatic latent image-holding member; transferring the toner image, which has not been fixed, onto a recording medium; and fixing the toner image on the recording medium, wherein the developer is the single-component magnetic developer of claim 1.
